(19) United States
(12) Patent Application Publication
(10) Pub. No.: US 2016/0223004 A1
(43) Pub. Date: Aug. 4, 2016

(54) UNIT LOCKING SYSTEM AND METHOD

(71) Applicant: ALCATEL - LUCENT CANADA, INC., Ottawa (CA)

(72) Inventor: Fabien Letourneau, Gatineau (CA)

(21) Appl. No.: 14/610,236

(22) Filed: Jan. 30, 2015

(51) Int. Cl. F16B 21/06; F16B 21/09

(52) U.S. Cl. CPC F16B 21/06; F16B 21/09

(57) ABSTRACT

The unit locking system includes a first fastening member having a proximal end having a first head portion and a distal end connected to a first surface and a second fastening member having a proximal end having a second head portion and a distal end connected to a second surface. The unit locking system further includes a unit having an aperture including an insertable first end portion and a slot portion having a second end portion. The insertable portion of the aperture is configured to receive the first head portion of the first fastening member and the second head portion of the second fastening member. The unit is locked to the mounting surface when the first head portion and second head portion are inserted into the aperture such that first fastening member engages the first end portion and the second fastening member is moved into engagement with the second end portion.

### TECHNICAL FIELD

The present invention relates to a locking system. More particularly, the invention relates to a locking system configured for securely fastening one or more components or units to a mountable surface using dual fastening members provided on the surface and a cooperating aperture formed on the unit.

### BACKGROUND

Conventional desktop units, home appliances and general public units are designed to have a modern, clean appearance when used for commercial purposes, as well as when used in a home. It is important that these devices are capable of being securely fastened to a surface, and at the same time have an aesthetically pleasing design. Conventionally, the aforementioned devices are mounted to a desired surface, typically using unitary fixed fastener on the surface and an aperture such as a keyhole provided on the device. The keyhole is typically configured to receive the fastener, and is provided in a hidden location on the bottom or backside of the device.

Typically, the fixed fastener has a body portion and a head portion, with the head portion having a dimension or diameter generally greater than that of the body. Wall or surface mounting is facilitated by first affixing the fastener to the surface and then aligning and inserting the device's keyhole larger portion over a head portion of the fastener. As such the unit is placed in a position such that the keyhole captures the head of the fastener in the narrow part of the keyhole slot.

For a vertically mounted unit, gravity provides a force holding the unit in place on the surface. While the aforementioned fixed fastener and aperture configuration may temporarily connect the unit to a surface, this arrangement is deficient in providing a secure locking connection. The aforementioned configuration is incapable of sustaining a vibration test typically required by industry standards. Furthermore, in this configuration, the unit maybe accidentally removed, as it is possible to accidentally lift the unit out of the slot upon impact. As most units perform critical functions in a system, accidental removal and/or unit failure during vibration, could be catastrophic to the overall functioning of a connected system.

### SUMMARY

In light of the present need for a unit locking, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

The unit locking system includes a unit having an aperture configured to receive a first fastening member and second fastening member therein. The unit locking system includes a first fastening member having a proximal end having a first head portion and a distal end connected to a first mountable surface. The unit locking system also includes a second fastening member having a proximal end having a second head portion and a distal end connected to a second surface.

The unit is locked to the mounting surface when the first head portion and second head portion are inserted into the aperture such that first fastening member engages the first end portion and the second fastening member is moved into engagement with the second end portion.

In an embodiment of the unit locking system, the first fastening member is fixed, and the second fastening member is connected to a second surface having a slidable locking arm member. The slidable locking member is configured to facilitate movement of the second fastening member relative to the first fastening member.

In an embodiment of the unit locking system, a biasing member is connected to the locking arm member.

In an embodiment of the unit locking system, the biasing member includes a spring configured to bias the locking arm member and connected second fastening member in a direction opposing the first fastening member.

In another embodiment of the unit locking system, the biasing member is the locking arm member having a flexible member configured to apply a locking biasing force on the second fastening member.

In yet another embodiment of the unit locking system, the locking arm member is configured for rotation about the mounting surface.

In another embodiment of the unit locking system, the first mountable surface is vertically orientated to receive vertical mounting of the unit thereon.

The method of fastening a unit to a surface includes providing a unit including an aperture having an insertable portion and a slot portion. Thereafter, providing a mountable surface having a first fastening member extending generally outward therefrom, the first fastening member having a first head portion. The method further includes providing a second surface having a slidable locking member and a second fastening member connected to the locking member.

The second fastening member is configured to engage the first fastening member, and further including a second head portion and placing the second fastening member in proximate engagement with the first fastening member forming a retention member. The method further includes inserting the retention member into the insertable portion of the aperture and moving one of the first fastening member or the second fastening member such that one of the members engages a first end portion of the aperture and the other member engages a second end portion of the aperture.

In another embodiment, the method of fastening a unit to a surface of further includes orientating the mountable surface vertically such that the first fastening member is positioned above the second fastening member and placing the second fastening member in proximate engagement with the first fastening member forming a retention member.

The method further includes aligning the unit such that the insertable portion of the aperture is aligned with the retention member. The method further includes positioning the slot portion above the insertable portion and inserting the retention member into the insertable portion of the aperture and then releasing the unit such that the first fastening member engages the first end portion of the slot portion and the second fastening member engages the second end portion of the aperture.

### BRIEF DESCRIPTION OF THE DRAWINGS

In order to better understand various exemplary embodiments, reference is made to the accompanying drawings, wherein:

FIG. 1 is an exploded perspective view of a portion of the unit locking system illustrating a split fastener arrangement in an unlocked position;

FIG. 2 is a perspective view of the locking system of FIG. 1 with the unit mounted thereon, illustrating split fasteners extending through an aperture provided on the unit;

FIG. 3 is a perspective view of the unit locking system of FIG. 1, illustrating one of the split fasteners positioned in a locking position without the unit mounted thereon;

FIG. 4 is a perspective view of the unit locking system of FIG. 1 with a unit mounted on the mountable surface, in a locked position;

FIG. 5 is a cross-sectional view of the unit locking system of FIG. 1, illustrating installation of the unit positioned on the mountable surface and split fasteners;

FIG. 6 is a cross-sectional view of the unit locking system of FIG. 1, illustrating the unit positioned on the mountable surface with a fixed first fastening member positioned at one end of the aperture;

FIG. 7 is a cross-sectional view of the unit locking system of FIG. 1, illustrating the unit positioned on the mountable surface with the second fastening member positioned at another end of the aperture, thereby locking the unit to the mountable surface;

FIG. 8 is a perspective view illustrating a latch in locking engagement with a catch for securing the locking arm;

FIG. 9 is an exploded view illustrating the unit locking system with a biasing member for moving the locking arm;

FIG. 10 is a cross-sectional view of the unit locking system of FIG. 9, with the unit mounted to the mountable surface, in an unlocked position;

FIG. 11 is a cross-sectional view of the unit locking system of FIG. 9, with the unit mounted to the mountable surface, biased in a locked position;

FIG. 12 is an illustration of a method of locking a unit or device to a surface using a split fastener and keyhole configuration;

FIG. 13 is another illustration of a method of vertically locking a unit to a vertically mounted surface using a split fastener and keyhole configuration;

FIG. 14 is perspective view of an embodiment of the unit locking system, illustrating a flexible locking arm member for biasing one of the split fastening members in a locking position;

FIG. 15 is a frontal view of the unit locking system embodiment of FIG. 14, in a locked position with a mounted unit;

FIG. 16 is perspective view of an embodiment of the unit locking system, illustrating dual flexible locking arm members for biasing one of the split fastening members in a locking position;

FIG. 17 is a frontal view of the unit locking system embodiment of FIG. 16, in an unlocked position with a vertically mounted unit;

FIG. 18 is a frontal view of the unit locking system embodiment of FIG. 16, in an locked position with a vertically mounted unit;

FIG. 19 is a perspective view of another embodiment of the unit locking system using a rotational member to control movement of one of the split fastening members between a locked and unlocked position;

FIG. 20 is an illustration of another embodiment of the unit locking system using dual rotating members to control movement of two split fasteners, in an unlocked position;

FIG. 21 is an illustration of another embodiment of the unit locking system using dual rotating members to control movement of two split fasteners, in a locked position;

FIG. 22 is an illustration of another embodiment of the unit locking system using a snap lock, in an unlocked position; and,

FIG. 23 is an illustration of the unit locking system of FIG. 22 showing the snap lock in a locked position.

To facilitate understanding, identical reference numerals have been used to designate elements having substantially the same or similar structure and/or substantially the same or similar function.

### DETAILED DESCRIPTION

It is important to provide a system that allows a unit to be fastened to a mountable surface in a manner that prevents accidental removal, and is sustainable in an environment that may experience vibration, such as an earthquake. Accordingly, it is desirable to provide a unit locking system that includes a mountable surface that incorporates multiple fasteners configured to provide two or more points of engagement within an aperture formed in the unit. It is further desirable that at least one of the fasteners, when inserted in the aperture of the unit, is movable from an unlocked position to a locked position.

The foregoing advantages of the invention are illustrative of those that can be achieved by the various exemplary embodiments and are not intended to be exhaustive or limiting of the possible advantages which can be realized. Thus, these and other advantages of the various exemplary embodiments will be apparent from the description herein or can be learned from practicing the various exemplary embodiments, both as embodied herein or as modified in view of any variation that may be apparent to those skilled in the art. Accordingly, the present invention resides in the novel methods, arrangements, combinations, and improvements herein shown and described in various exemplary embodiments.

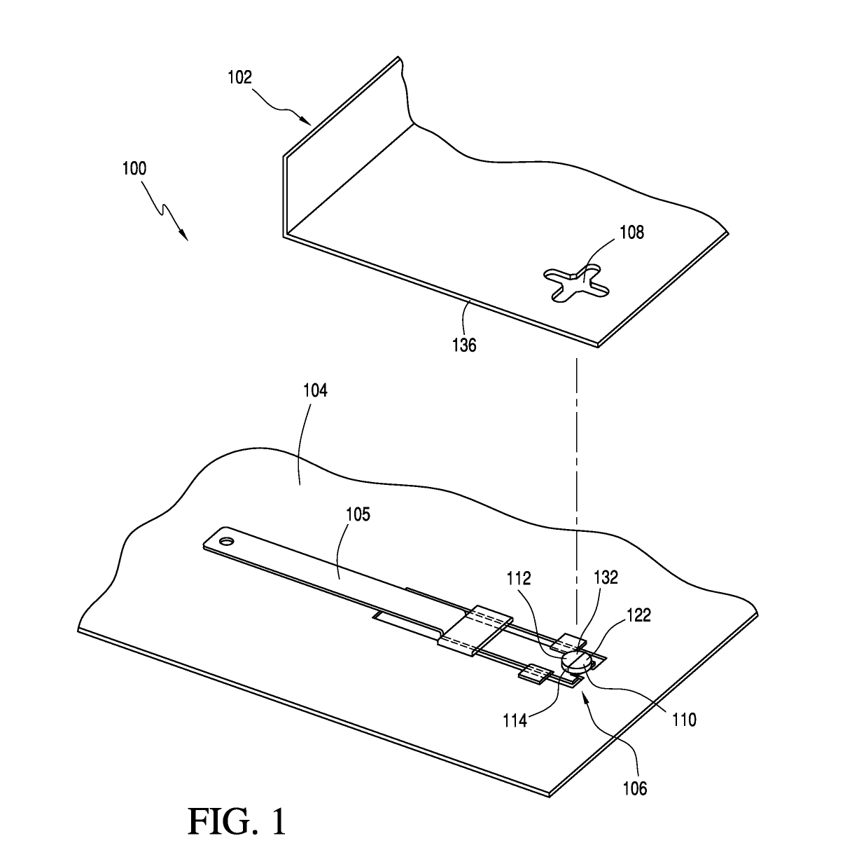

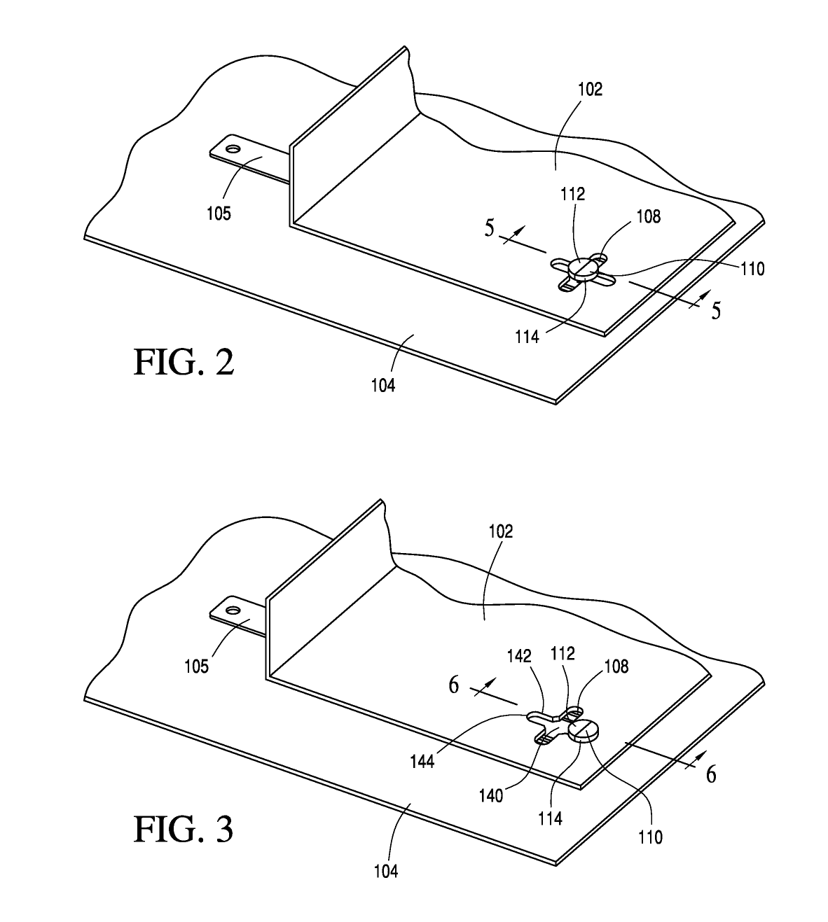

Referring now to the drawings, wherein the illustrations are for purposes of describing one or more embodiments and not for the purposes of limiting the same, FIGS. 1-4 illustrate an embodiment of the unit locking system 100 configured for securely mounting one or more components or units 102 to a mountable surface 104. The mountable surface 104 may be comprised of a material such as, sheet metal or plastic, for example. As illustrated, the locking system 100 generally includes a fastening assembly 106, provided in conjunction with the surface 104, and one or more apertures or keyholes 108 disposed on the unit 102.

The fastening assembly 106, provided on the surface 104, and the aperture 108, provided on the unit 102, are configured to provide locking engagement therebetween. As shown, the fastening assembly 106 generally includes a first fastening member 110 and a second fastening member 112, which in cooperative engagement, form a retention member 114. The jointly formed retention member 114 is configured for insertion into the aperture 108 of the unit 102. As shown in FIG. 1, the first fastening member 110 is provided on the first mounting surface 104 of the unit 102, and includes a first body 116 (as shown in FIG. 5), which includes a proximal end 118, and a distal end 120. The distal end of the first fastening member 110 is connected to the surface 104 and extends generally outwardly therefrom.

As shown in FIG. 3, the first fastening member 110 may have a generally semi-cylindrical shape configured for engagement with a portion of the aperture 108. It is also contemplated that the first fastening member 110 may have a T-shaped cross-section configuration, in which the proximal end 118 includes a first head portion 122 configured for retention inside of the aperture 108. In general, the first head portion 122 has a diameter or width, larger than that of the body 116. Notably, other configurations for the first head portion 122 are contemplated, such as square shaped, or triangular shape, for example. As shown for the purposes of this embodiment, the first fastening member 110 may be fixed to the mounting surface 104. However, it is contemplated that the first fastening member 110 may also be provided for sliding movement relative to the aperture 108, if desired.

The second fastening member 112 includes a body 126 (as shown in FIG. 5) having a distal end 128 and a proximal end 130 configured for insertion into the aperture 108. As previously stated, the second fastening member 112 is configured for cooperative engagement with the first fastening member 110, thereby forming the two-part retention member 114 when in an engaged position. The distal end 128 is connected to a second surface 105 or a locking arm member 105, extending generally outwardly therefrom. The proximal end 130 includes a second head portion 132 configured for retention in the aperture 108, when placed in an inserted position therein. Accordingly, the second head portion 132 has a diameter or configuration generally larger in width or diameter than that of the body 126. As shown in this embodiment, the body 126 may have a semi-cylindrical shape and the second head portion 132 may have a semi-circular shape.

The second fastening member 112 is configured for slidable movement within the aperture 108, to securely lock the second fastening member 112 and the first fastening member 110 to unit 102. As shown, the second fastening member 112 is insertable into the aperture 108 or keyhole. The first fastening member 110 is fixed and the second fastening member 112 is movable relative to the first fastening member 110. While in the disclosed embodiment the first fastening member 110 is fixed, it is contemplated that the locking member 100 may be configured such that the first fastening member 110 is a slidable member capable of sliding within the aperture 108 as well.

In the embodiment disclosed in FIGS. 1-4, the aperture 108 or keyhole may be located generally on the bottom surface 136 of the unit 102. Notably, it is also contemplated that the aperture 108 may be provided at any desired mounting location on the unit 102, including the side portion or top portion of the unit 102, if desired. Additionally, as illustrated in FIGS. 1-4, the mountable surface 104 may be configured in a generally horizontal orientation, such that the unit 102 may be placed on top of the mountable surface 104. Notably, it is further contemplated that the mountable surface 104 may have a virtually any orientation, including a vertical or inclined orientation, without departing from the scope of the invention.

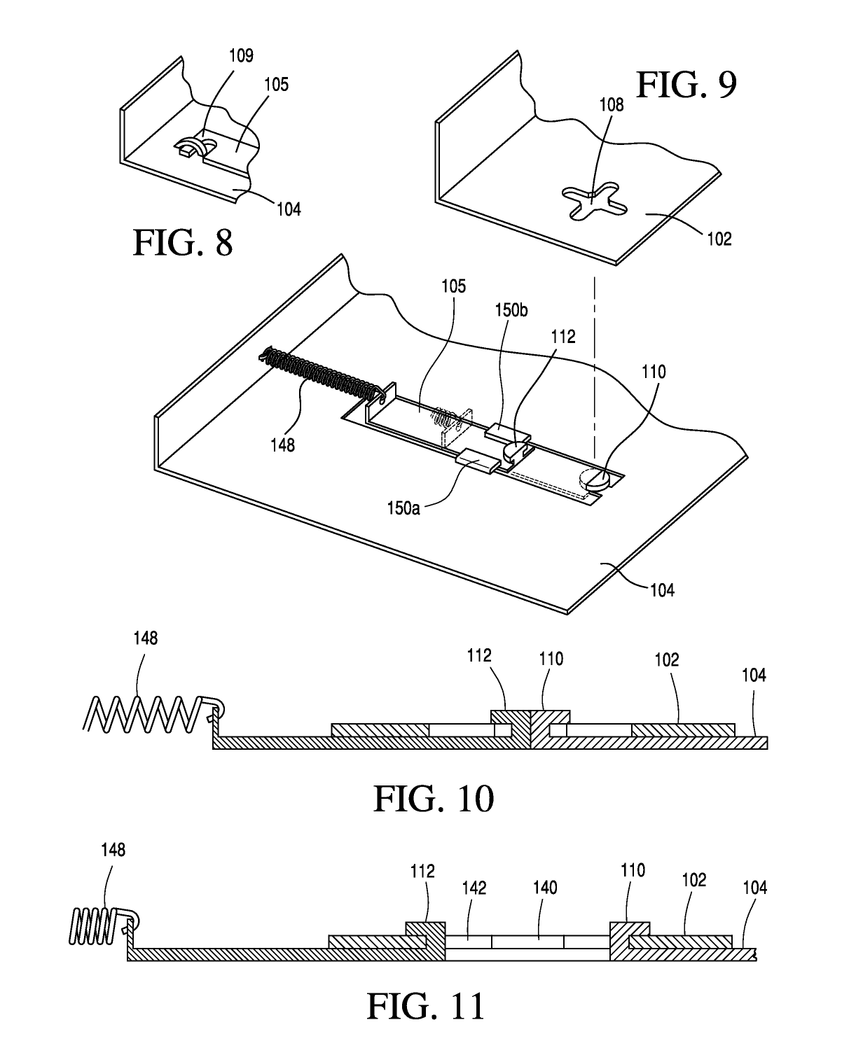

The locking arm member 105 is configured to move in a desired direction, to actuate movement of the second fastening member 112. The locking arm member 105 may be accessed generally from the edges of the unit 102. As shown in FIG. 8, the locking arm member 105 may be locked in place by locking features such as a cam, screw, hook or catch 109, for example. By using various linkages and pivot points, the locking arm member 105 may be easily adaptable to be configured in a wide variety of shapes and therefore may function in cooperation with a wide range of features. Similar to that of the mounting surface 104, it is contemplated that the locking arm member 105 may be formed using sheet metal, or cast in another material formable through die-casting.

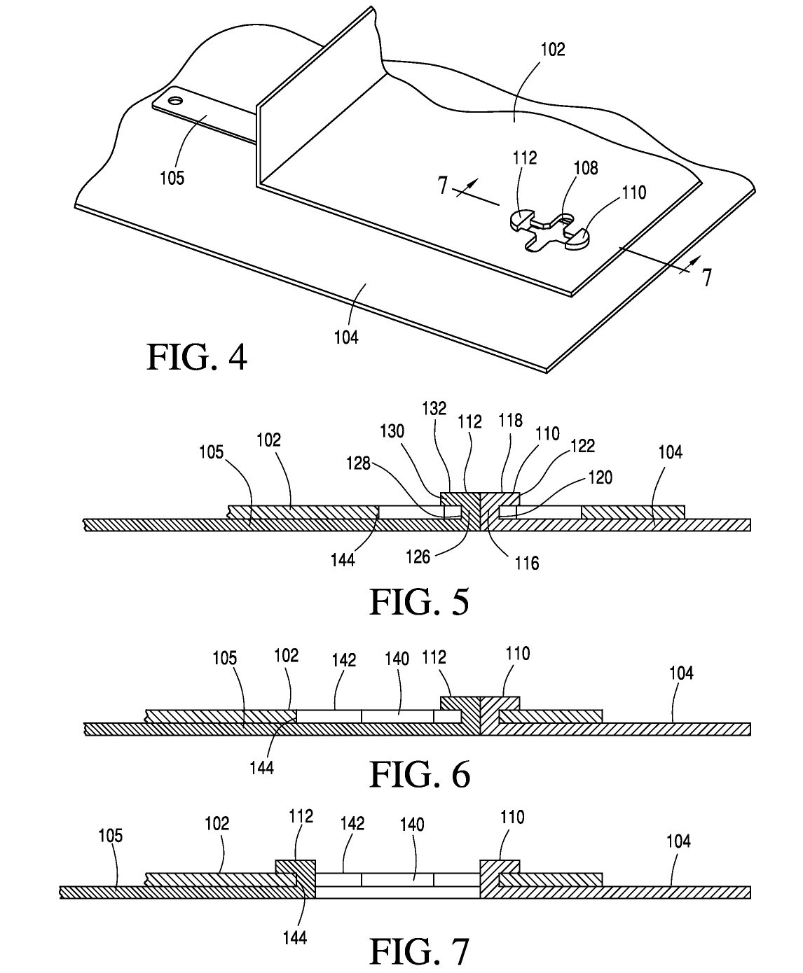

As shown, the keyhole or aperture 108 may have a variety of configurations suited to facilitate locking engagement with the first fastening member 110 and second fastening member 112. The overall configuration of the aperture 108 is generally dependent on the desired locking movement of the fastening members 112 and 110. As shown, the aperture 108 may have a cross-shaped configuration or a generally keyhole shaped configuration, for example. In one example, the aperture 108 has a generally insertable portion 140 (as shown in FIG. 4), having a generally circular configuration, and an extended slot portion 142. The insertable portion 140 has a dimension sufficient to receive simultaneous insertion of the first fastening member 110 and the second fastening member 112, when the fastening members 110 and 112 are in an engaged joined position.

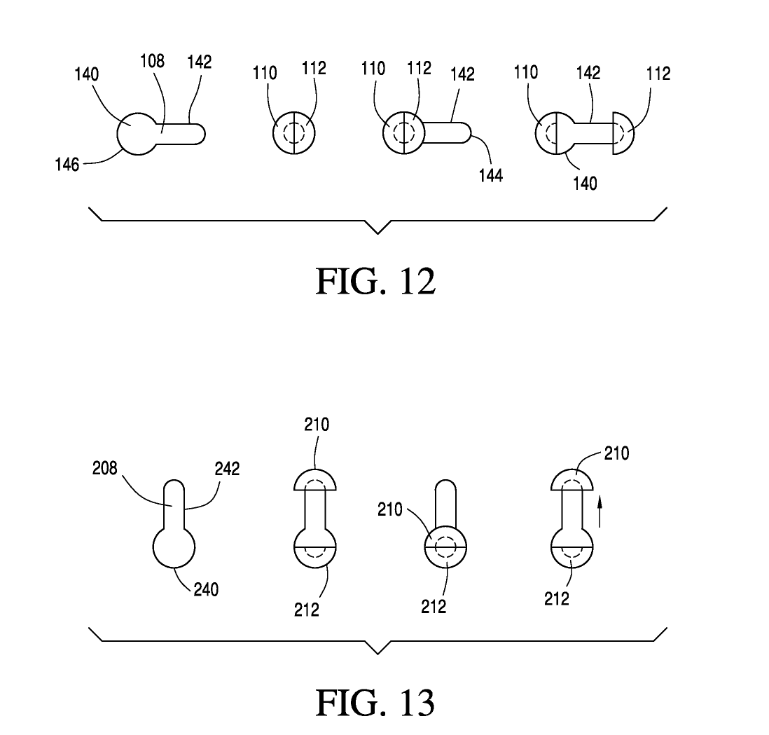

As shown, the slot portion 142 of the aperture 108 may have a width that is less than the width or diameter of the head portions 122 and 132, formed on each of the respective first fastening member 110 and second fastening member 112. As shown in FIG. 12, for example, once the respective head portions 122 and 132 are inserted in the insertable portion 140, the unit 102 maybe secured by sliding the unit and/or one or both of the fastening members 110, 112 into the slot portion 142. As such, the head portion 132 of the second fastening member 112 having a size larger than that of the slot 142 is retained at the end portion 144 of the slot 142, providing a first connection, and the first fastening member 110 is retained at the opposing end 146 of the aperture 108, providing a second connection. As shown, the generally straight slot configuration, facilitates longitudinal movement of the second fastening member 112 and locking arm 105 relative to the first fastening member 110.

As shown in FIGS. 5-7, in operation the first fastening member 110 and second member 112 are placed in an engagement with each other, forming the retention member 114. The unit 102 is positioned, such that the aperture 108, formed on the engaging surface, is aligned with the retention member 114. The respective first head portion 122 of the first fastening member 110 and second head portion 132 of the second fastening member 112 are inserted through the aperture 108. The movable member, which in this case is the second fastening member 112, is moved within the aperture 108, which in this case is the slot portion 142, such that the second fastening member 112 engages the end portion 144 of the aperture 108. The respective larger dimensioned head portion 132 secures the second fastening member 112 within the slot 142, and the first fastening member 110 is secured in the aperture 108 thus locking the unit 102 to the mountable surface 104.

It is contemplated that the first fastening member 110, second fastening member 112 or both members, maybe biased in the locked position or unlocked by a biased member such as a spring 148 or connected flexible member. As shown in FIGS. 9-11, the second fastening member 112 is connected to a slidable locking arm 105 The locking arm 105 is positioned in generally the same plane as the mounting surface 104, and as such, the second fastening member 112 is movable within the slot portion 142 formed in the mounting surface 104. The second fastening member 112 and locking arm 105 are biased by the spring 148. As such, the spring 148 provides a biasing forcing, forcing the second fastening member 112 and locking arm 105 in the direction of a locking position. Dual abutments 150a and 150b are provided on the mountable surface 104 to limit movement the locking arm 105 to longitudinal movement. As such, in operation, once the aperture 108 of the unit 102 is placed over the retention member 114, the second fastening member 112 is released, and the spring 148 forces the second fastening member 112 to slide into a locked position, engaging the end portion 144 of the aperture 108.

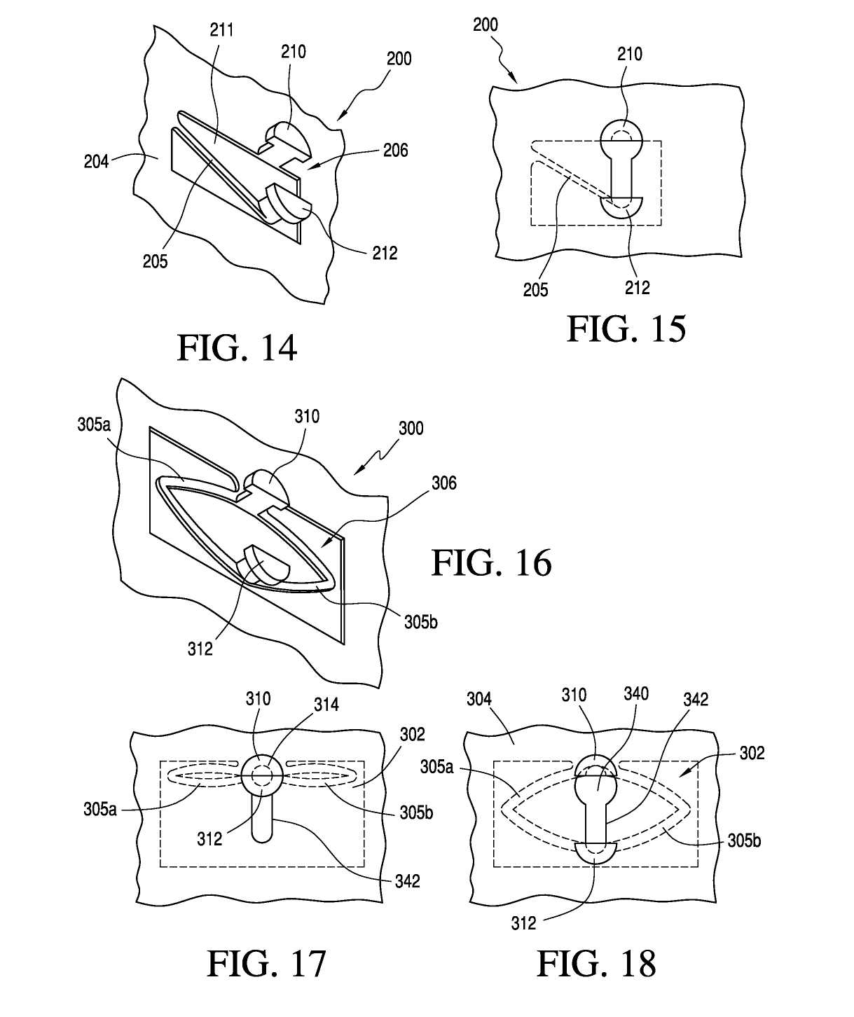

In an embodiment shown in FIG. 14-15, the unit locking system 200 may be used in conjunction with a surface orientated in a vertical or horizontal orientation. As shown, the unit locking system 200 includes a fastening member assembly 206 which may be biased into a locked position using one or more pre-loaded flexible locking arms 205. As shown, the first fastening member 210 may be fixed to the mountable surface 204 and the second fastening member 212 may be connected to one more flexible arm members 205, configured to bias the second fastening member 212 in a locked position. As shown in the figures, the locking system 200 may be vertically orientated such that unit 102 and aperture 108 may be vertically mounted to the mountable surface 204.

As shown, the flexible locking arm member 205 may be provided in opening 211, facilitating rotational movement of the locking arm 205 and connected second fastening member 212. In operation, the biased second fastening member 212 is forced into engagement with the first fastening member 210. As previously described, the unit 102 (not shown) having an aperture 208 formed therein is mounted to the surface 204. In the embodiment shown, the aperture 208 has a keyhole configuration, and the retaining assembly 114 (comprised of the second head portion and first head portion) is inserted in the keyhole 208. The second fastening member 212 is released from engagement with the first fastening member 210, and slides along the keyhole, locking the unit 102 to the surface 204.

In a vertical arrangement illustrated in FIG. 13, the key hole 208 on the mounting surface is positioned such that the slot portion 242 is positioned above the insertable circular portion 240. In operation, the circular portion 240 engages the second fastening member 212 and the unit 102 is moved up to also engage the fixed first fastening member 210. Thereafter, the unit 102 is released down such that the first fastening member 210 remains positioned in the slot portion 242 of the keyhole 208, and the second fastening member 212 flexes into position engaging the end portion 240.

In an embodiment shown in FIGS. 16-18, the unit locking system 300 and fastening member assembly 306 may include dual locking arm members 305a and 305b. As shown the first fastening member 312 is provided central to the first biasing arm 305a and, and the second fastening member is provided central to the second biasing arm 305b. The second fastening member 312 is pressed against the first fastening member 310, forming a retaining member 314. In accordance with the keyhole and/or apertures illustrated in FIGS. 1-4 and 12, the unit 102 having an aperture 208 formed therein is mounted to the surface 304 such that the head portions of fastening members 310 and 312 are inserted in the insertable portion of the aperture or keyhole 208. Thereafter, second fastening member 312 biased in an opposing direction, is released from engagement with the first fastening member 310, and is free to slide along the slot portion 342 of the keyhole 208, locking the unit 102 to the mountable surface 304. In an alternate method, the insertable portion 340 engages the second fastening member 312 and the unit 302 is moved in an upward direction to permit engagement with the fixed first fastening member 310. Thereafter, the unit 102 is released in a downward direction such that the first fastening member 310 remains positioned in the slot portion 242 of the keyhole 208, and the second fastening member 312 and locking arms 305a and 305b forces the second fastening member 312 into a position engaging the insertable portion 240.

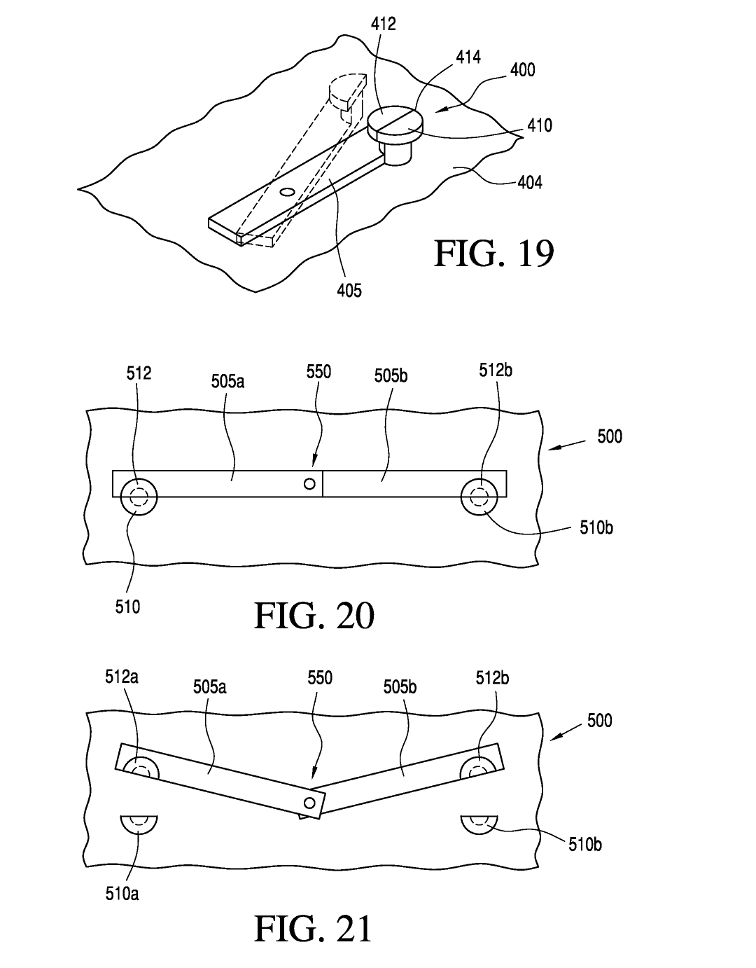

In an embodiment shown in FIG. 19, the locking system 400 may use a rotational locking arm member 405 to lock and unlock the unit to the mountable surface 404. In this configuration, the first fastening member 410 is fixed to the mountable surface 404 and the second fastening member 412 is provided on a rotatable surface, such the rotatable locking arm member 405. In a mounting position, the first fastening member 410 and second fastening member 412 are placed in engagement forming the retaining member 414.

Thereafter, a unit 102 and aperture 108 (as previously shown in FIGS. 1-4) may be placed in alignment with the retention member 414, which is inserted therein. In this embodiment, it is contemplated that the aperture 108 may have a curved slot portion that accommodates rotational movement of the second fastening member 412 therein. The unit 102 and aperture 108 are secured to the surface 104 by rotating the rotatable locking arm 405 such that the second fastening member 412, in an inserted position, travel long the slot, into a locked position.

In an embodiment shown in FIGS. 20-21, a dual rotational unit locking system 500 operates similarly to the aforementioned rotational locking system 400. As shown the rotational arms 505a and 505b are connected at a hinge 550. Force applied proximate to the hinge 550 actuates both rotating locking arms 505a and 505b to rotate, pressing the inserted second fastening members 512a and 512b into locking engagement with an aperture, while the first fastening members 510a and 510b remain fixed.

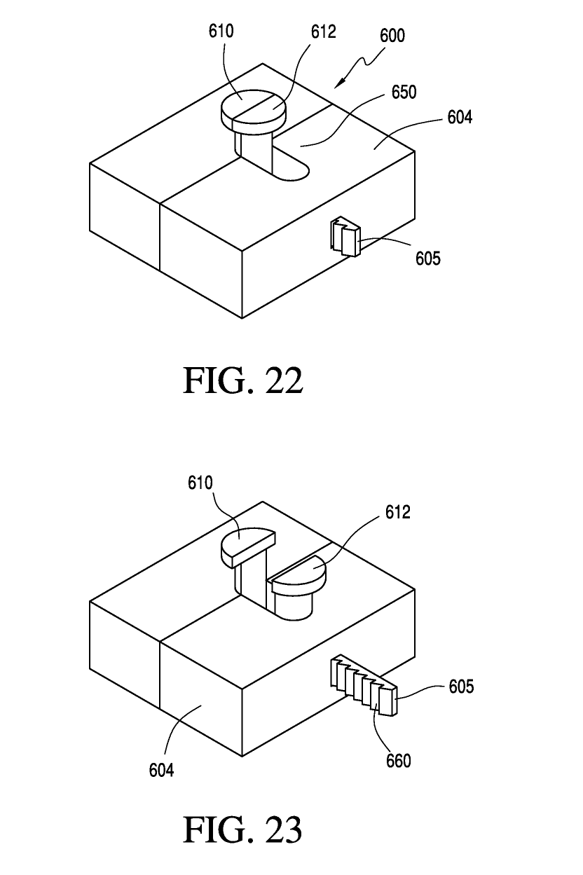

As shown in an embodiment disclosed in FIGS. 22-23, the unit locking system 600, in conjunction with a mountable surface 604, may use a snap locking assembly 650 to actuate movement of the second locking arm 605 and connected the second fastening member 612 relative to the first fastening member 610. As shown, plural abutment 660 controls longitudinal movement of the second fastening member 612 relative to the first fastening member 610, from an unlocked to locked position.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A unit locking system, including a unit having an aperture configured to receive a fastening member therein, the unit locking system comprising:
a first fastening member having a proximal end having a first head portion and a distal end connected to a first mountable surface; and,
a second fastening member having a proximal end having a second head portion and a distal end connected to a second surface,
wherein the unit is locked to the mounting surface when the first head portion and second head portion are inserted into the aperture such that first fastening member engages the first end portion and the second fastening member is moved into engagement with the second end portion.

2. The unit locking system of claim 1, wherein the first fastening member is fixed, and the second fastening member is connected to second surface having a slidable locking arm member, configured to facilitate movement of the second fastening member relative to the first fastening member.

3. The unit locking system of claim 1, wherein the first fastening member has a generally cylindrically shaped configuration.

4. The unit locking system of claim 1, wherein the second fastening member has a T-shaped cross-section.

5. The unit locking system of claim 1, wherein the first mountable surface is vertically orientated to receive vertical mounting of the unit thereon.

6. The unit locking system of claim 1, wherein the locking arm member is in engagement with a snap locking device to control movement of the second fastening member relative to the first fastening member

7. The unit locking system of claim 1, wherein the aperture has a keyhole configuration including a generally circular portion and a slot portion.

8. The unit locking system of claim 2, wherein a biasing member is connected to the locking arm member.

9. The unit locking system of claim 8, wherein the biasing member includes a spring configured to bias the locking arm member and connected second fastening member in a direction opposing the first fastening member.

10. The unit locking system of claim 8, wherein the biasing member is the locking arm member having a flexible member configured to apply a locking biasing force on the second fastening member.

11. The unit locking system of claim 8, wherein the locking arm member includes plural flexible members connected to the second fastening member.

12. The unit locking system of claim 8, wherein the locking arm member is configured for rotation about the mounting surface.

13. The unit locking system of claim 8, wherein the locking arm member includes dual locking arms connected at a pivot point.

14. A method of fastening a unit to a surface, comprising:
providing a unit having an aperture having an insertable portion and a slot portion;
providing a mountable surface having a first fastening member extending generally outward therefrom, the first fastening member having a first head portion;
providing a second surface having a slidable locking member and a second fastening member connected to the locking member, the second fastening member being configured to engage the first fastening member, and further including a second head portion;
placing the second fastening member in proximate engagement with the first fastening member forming a retention member;
inserting the retention member into the insertable portion of the aperture; and,
moving one of the first fastening member or the second fastening member such that one of the members engages a first end portion of the aperture and the other member engages a second end portion of the aperture.

15. The method of fastening a unit to a surface of claim 14, further comprising:
orientating the mountable surface such that the first fastening member is positioned in an engagement relation to the second fastening member;
placing the second fastening member in proximate engagement with the first fastening member forming a retention member;
aligning the unit such that the insertable portion of the aperture is aligned with the retention member wherein the slot portion is positioned above the insertable portion;
inserting the retention member into the insertable portion of the aperture; and,
releasing the unit such that the first fastening member engages the first end portion of the slot portion and the second fastening member engages the second end portion of the aperture.
